(19) United States
(12) Patent Application Publication
(10) Pub. No.: US 2004/0189052 A1
(43) Pub. Date: Sep. 30, 2004

(54) Extended pick-up truck cab with configurable interior cargo space

(76) Inventors: Gordon M. Heidacker, Bloomfield Hills, MI (US); James T. Baker, Ann Arbor, MI (US); Mark W. Geiger, West Bloomfield, MI (US)

Correspondence Address: Ralph E. Smith, DaimlerChrysler Intellectual Captial Corporation, CIMS 483-02-19, 800 Chrysler Drive, Auburn Hills, MI, 48326-2757, US

(21) Appl. No.: 10/397,568

(22) Filed: Mar. 26, 2003

(51) Int. Cl. B62D 33/06

(52) U.S. Cl. 296/190.08

(57) ABSTRACT

An extended cab for a pick-up truck includes an interior cargo storage space between a rearwardmost portion of a rear seat and the rear wall of the cab.

### FIELD OF THE INVENTION

The invention relates generally to extended cab pick-up trucks. More particularly, the invention concerns an extended pick-up truck cab having an interior cargo space.

### BACKGROUND OF THE INVENTION

The ever-increasing popularity of pick-up trucks has been fostered, in part, by an ever-increasing array of features making such trucks attractive as family vehicles. Such features include designing the interior of the truck cab to more clearly resemble large sedans or sport utility vehicles. Hence, current pick-up truck offerings include extended cabs with rear seating for additional passengers.

Missing, to date, from newly offered features is an extended cab with rear seats and an interior cargo space to the rear of the rear seats.

### SUMMARY OF THE INVENTION

Accordingly, an interior for a cab of a pick-up truck includes at least one front seat for a vehicle operator, and at least one rear seat, rearwardly positioned in spaced relation to the at least one front seat, for at least one passenger, wherein the interior of the cab is dimensioned such that a rear wall of the cab is always spaced from a rearwardmost portion of the at least one rear seat to form a cargo storage space between the at least one rear seat and the rear wall of the cab.

### BRIEF DESCRIPTION OF THE DRAWING

The objects and features of the invention will become apparent from a detailed description, taken in conjunction with the drawing, in which:

FIG. 1 is a side view of a pick-up truck arranged in accordance with the principles of the invention; and

FIG. 2 is a side view of a pick-up truck having a “flip and fold” rear seat for expanding an interior cargo space in accordance with the principles of the invention.

### DETAILED DESCRIPTION

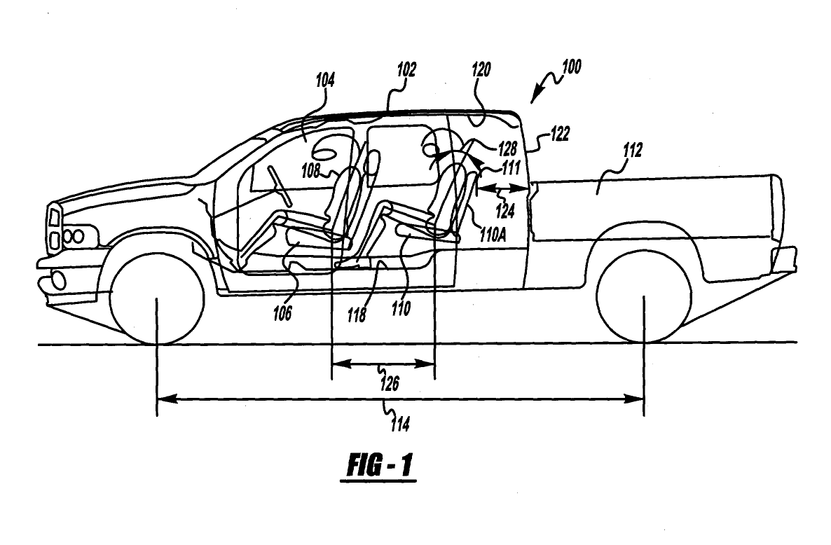

FIG. 1 sets forth a pick-up truck having a cab interior arranged in accordance with the principles of the invention. Truck 100 has a cab 102 defining a cab interior 104. The interior includes a front seat 106 for a vehicle operator 108 and a rear passenger seat 110 spaced to he rear of the front seat 106 for accommodating one or more rear passengers 116.

Located rearwardly of rear seat 110 is an interior cargo space extending from a floor 118 of the cab to a ceiling 120 thereof and from a rearwardmost position 111 of rear seat 110 to a rear wall 122 of the cab for a distance shown by length 124.

External cargo bed 112 extends from the cab's rear wall 122 to the rear end of the vehicle.

Hence, it will be seen from FIG. 1 that pick-up truck 100 has a cab interior which includes a rear interior cargo space having a horizontal dimension of at least that shown by arrow 124 and a vertical dimension extending from the floor 118 to the ceiling 120 of the cab interior 104.

The extended cab arrangement shown in FIG. 1 also enables a more optimized positioning of rear seat 110 with respect to the front seat 106. For example, the distance of the couple 126 between the front and rear seating system can be increased. Additionally, the back angle 128 of rear seat backrest portion 110A can be increased.

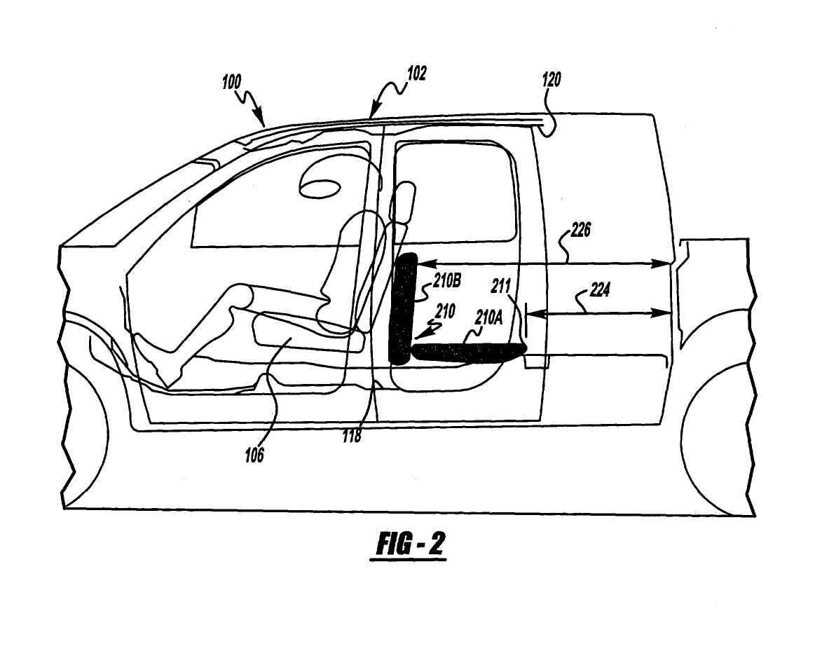

FIG. 2 is a side view of a pick-up truck cab also arranged in accordance with the principles of the invention but featuring a so-called “flip and fold” rear seat 210. Rear seat 210 when in the seating or deployed position is as shown in the seat 110 configuration of FIG. 1. When it is desired to increase the interior cargo space of cab 102, first the seat cushion portion 210B is pivoted or flipped about its front surface to an upright position shown in FIG. 2, and then the backrest 210A of rear seat 210 is folded down to a horizontal position. Hence, the term “flip and fold” is used. With the rear seat 210 in the stowed position shown in FIG. 2, it becomes apparent that the interior space in the cab 102 available for cargo storage is increased in the horizontal direction to a distance 226. The vertical space above the rear seat 210 then extends from the folded down backrest 210A to the roof 120 of cab 102. It will be seen that a higher vertical cargo space from floor 118 to ceiling 120 will still be maintained but will extend from a rearwardmost point 211 of the stowed rear seat 210 a distance 224 to the rear wall of the cab.

In one specific example of a pick-up truck design being considered for employing the invention, economies are realized in utilizing a chassis with a wheel base 114 (FIG. 1) of an existing pick-up truck model. Additionally, a smaller but previously designed external cargo bed 112 may be utilized with the same wheel base 114 to provide room for the extension at the rearward portion of cab 102 embodying the invention. Using such preexisting components avoids the necessity for new designs of both the chassis and the cargo bed and enables a more economical introduction of a vehicle featuring the principles of the invention.

Assume, for example, that the vehicle manufacturer currently offers two versions of an extended cab pick-up truck: The first version has a wheel base of 140.5 inches and uses an external cargo box six feet four inches long. The second version utilizes a wheel base of 160.5 inches and uses an eight foot two inches long cargo box. A new extended cab with interior rearwardly positioned cargo space as described above could then be designed using the existing chassis for the longer 160.5 inch wheel base with the smaller six foot four inch box to allow expansion of the cab by approximately 20 inches to form the interior cargo space.

Similar approaches could lead to designs employing the rear interior floor-to-ceiling cargo space having horizontal dimensions on the order of about six inches to about 36 inches.

The invention has been described with reference to a specific example herein. The scope and spirit of the invention are not to be limited by the example set forth but are to be interpreted in accordance with the appended claims.

What is claimed is:

1. An interior for a cab of a pick-up truck comprising:
at least one front seat for a vehicle operator; and
at least one rear seat, rearwardly positioned in spaced relation to the at least one front seat, for at least one passenger;
wherein the interior of the cab is dimensioned such that a rear wall of the cab is always spaced from a rearwardmost portion of the at least one rear seat to form a cargo storage space between the at least one rear seat and the rear wall of the cab.

2. The interior of claim 1 wherein the cargo storage space extends from a floor of the cab to a ceiling of the cab.

3. The interior of claim 1 wherein the space between the rearwardmost portion of the at least one rear seat and the rear wall of the cab is on the order of about six inches to about 36 inches.

4. The interior of claim 1 wherein the space between the rearwardmost portion of the at least one rear seat and the rear wall of the cab is on the order of about 20 inches.

5. The interior of claim 1 wherein the at least one rear seat can be rotatably stowed to increase the cargo storage space.

6. In a pick-up truck having a cab equipped with at least one front seat for a vehicle operator, at least one rear seat, rearwardly positioned in spaced relation to the at least one front seat, for at least one passenger, and an external cargo bed extending rearwardly from the cab, the improvement comprising:
a rearward extension of the cab into a space normally associated with the external cargo bed whereby the cab is provided with an interior cargo space extending between a rearwardmost portion of the at least one rear seat and a rear wall of the cab.

7. The improvement of claim 6 wherein the cargo space extends from a floor of the cab to a ceiling of the cab.

8. The improvement of claim 6 wherein the space between the rearwardmost portion of the at least one rear seat and the rear wall of the cab is on the order of about six inches to about 36 inches.

9. The improvement of claim 6 wherein the space between the rearwardmost portion of the at least one rear seat and the rear wall of the cab is on the order of about 20 inches.

10. The improvement of claim 6 wherein the at least one rear seat can be rotatably stowed to increase the cargo storage space.

11. A pick-up truck comprising:
a cab defining an interior compartment containing at least one front seat for a vehicle operator, and at least one rear seat, rearwardly positioned in spaced relation to the at least one front seat, for at least one passenger, wherein the interior of the cab is dimensioned such that a rear wall of the cab is always spaced from a rearwardmost portion of the at least one rear seat to form a cargo storage space between the at least one rear seat and the rear wall of the cab; and
an external cargo bed extending rearwardly from the rear wall of the cab.

12. The pick-up truck of claim 11 wherein the cargo storage space extends from a floor of the cab to a ceiling of the cab.

13. The pick-up truck of claim 11 wherein the space between the rearwardmost portion of the at least one rear seat and the rear wall of the cab is on the order of about six inches to about 36 inches.

14. The pick-up truck of claim 11 wherein the space between the rearwardmost portion of the at least one rear seat and the rear wall of the cab is on the order of about 20 inches.

15. The pick-up truck of claim 11 wherein the at least one rear seat can be rotatably stowed to increase the cargo storage space.
